(19) United States
(12) Patent Application Publication
(10) Pub. No.: US 2018/0312677 A1
(43) Pub. Date: Nov. 1, 2018

(54) RESIN COMPOSITION AND MOLDED BODY OF SAME

(71) Applicant: IDEMITSU KOSAN CO., LTD., Chiyoda-ku (JP)

(72) Inventors: Nozomu FUJII, Sumida-ku (JP); Masahiro KUBO, Chiba-shi (JP)

(73) Assignee: IDEMITSU KOSAN CO., LTD., Chiyoda-ku (JP)

(21) Appl. No.: 15/772,177

(22) PCT Filed: Oct. 24, 2016
(86) PCT No.: PCT/JP2016/081408

§ 371 Date: Apr. 30, 2018

(30) Foreign Application Priority Data
Nov. 6, 2015 (JP) 2015-218580

(51) Int. Cl. C08L 23/14; C08J 5/04

(52) U.S. Cl. CPC C08L 23/142; C08J 5/042; C08F 10/06; C08J 2323/14; C08J 5/043

(57) ABSTRACT

A resin composition containing (a) an olefinic polymer (A) having a melting endotherm (ΔH-D) of 0 J/g or more and 80 J/g or less and a molecular weight distribution (Mw/Mn) of less than 3.0, (b) an olefinic polymer (B) having a melting point (Tm-D) of 100° C. or higher, and (c) fibers (C) having an aspect ratio of 10 or more, and a mean fiber diameter of 0.01 μm or more and 1,000 μm or less.

### TECHNICAL FIELD

The present invention relates to a resin composition and a molded article thereof.

### BACKGROUND ART

Heretofore, a fiber-reinforced resin molded article is known, which contains fibers such as glass fibers so as to have reinforced mechanical properties. The fiber-reinforced resin molded article is excellent in mechanical properties such as tensile strength, bending strength and bending elasticity and in heat resistance, and is therefore widely utilized for exterior materials for daily-use home electrical appliances, for automobile parts such as instrument panel cores, bumper beams, door steps, roof racks, rear quarter panels, air cleaner cases and wheel covers, and for building members and civil construction members such as outer wall panels, partition wall panels and cable troughs (for example, see PTLs 1 to 3). In producing such fiber-reinforced resin molded articles, injection molding can be utilized, in which a molten resin containing fibers is injected into the inside of a mold. Merits of such injection molding are that even intricately shaped articles can be molded and, in addition, since a predetermined molding cycle can be continuously repeated, articles having the same shape can be mass-produced in large quantities.

### CITATION LIST

### Patent Literature

PTL 1: JP 11-333878 A

PTL 2: JP 11-235902 A

PTL 3: JP 10-176085 A

### SUMMARY OF INVENTION

### Technical Problem

A fiber-reinforced resin containing fibers such as glass fibers may have improved stiffness and heat resistance but has a low resin flowability and is poor in mold transferability, and is therefore poor in designability in producing molded articles. In particular, in the case of a glass fiber-reinforced polypropylene resin, the propylenic resin has poor adhesiveness to glass fibers and therefore the ends of glass fibers may often protrude out of the surfaces of molded articles to significantly worsen the outward appearance thereof, and consequently, such a glass fiber-reinforced polypropylene resin is used little in parts that require a good appearance.

Accordingly, the technical problem to be solved by the present invention is to provide a resin composition being excellent in flowability and mold transferability and capable of providing an excellent appearance, and to provide a molded article thereof.

### Solution to Problem

As a result of assiduous studies, the present inventors have found that, when an olefinic polymer (A) having a relatively low melting endotherm and having a specific structure and fibers (C) are blended in an olefinic polymer (B) having a melting point of 100° C. or higher, the above-mentioned problems can be solved. Based on such a finding, the inventors have completed the present invention.

Specifically, the present invention provides the following:

<1> A resin composition containing:

(a) an olefinic polymer (A) having a melting endotherm (ΔH-D) of 0 J/g or more and 80 J/g or less, which is defined as the area of a peak observed on the highest temperature side in a melting endothermic curve obtained with a differential scanning calorimeter (DSC) by keeping a sample of the polymer in a nitrogen atmosphere at −10° C. for 5 minutes and then heating the sample at 10° C./min; and having a molecular weight distribution (Mw/Mn) of less than 3.0,

(b) an olefinic polymer (B) having a melting point (Tm-D) of 100° C. or higher, which is defined as the peak top observed on the highest temperature side in a melting endothermic curve obtained with a differential scanning calorimeter (DSC) by keeping a sample of the polymer in a nitrogen atmosphere at −10° C. for 5 minutes and then heating the sample at 10° C./min, and

(c) fibers (C) having an aspect ratio of 10 or more and a mean fiber diameter of 0.01 μm or more and 1,000 μm or less.

<2> The resin composition according to the above <1>, wherein the content of the olefinic polymer (A) is 0.5% by mass or more and less than 50% by mass, relative to 100% by mass of the total content of the olefinic polymer (A) and the olefinic polymer (B).
<3> The resin composition according to the above <1> or <2>, wherein the olefinic polymer (A) is a propylenic polymer.
<4> The resin composition according to any one of the above <1> to <3>, wherein the olefinic polymer (B) is a propylenic polymer.
<5> The resin composition according to any one of the above <1> to <4>, wherein the olefinic polymer (A) is a propylenic polymer (a1) in which a propylene monomer accounts for 50 mol % or more of monomers constituting the polymer (a1).
<6> The resin composition according to the above <5>, wherein the propylenic polymer (a1) satisfies at least one of the following (i) and (ii):

(i) an ethylene structural unit is contained in an amount of more than 0 mol % and 20 mol % or less, and

(ii) a 1-butene structural unit is contained in an amount of more than 0 mol % and 30 mol % or less.

<7> The resin composition according to the above <5>, wherein the propylenic polymer (a1) satisfies the following (1):

(1) the meso pentad fraction [mmmm] is 20 mol % or more and 60 mol % or less.

<8> The resin composition according to any one of the above <5> to <7>, wherein the propylenic polymer (a1) satisfies the following (2):

(2) the melting point (Tm-D), which is defined as the peak top observed on the highest temperature side in a melting endothermic curve obtained with a differential scanning calorimeter (DSC) by keeping a sample of the polymer in a nitrogen atmosphere at −10° C. for 5 minutes and then heating the sample at 10° C./min, is 0° C. or higher and 120° C. or lower.

<9> The resin composition according to the above <7> or <8>, wherein the propylenic polymer (a1) satisfies the following (3):

(3) the value of [rrrr]/(1−[mmmm]) is 0.1 or less.

<10> The resin composition according to any one of the above <7> to <9>, wherein the propylenic polymer (a1) satisfies the following (4) and (5):

(4) the racemic meso racemic meso pentad fraction [rmrm] is more than 2.5 mol %, and

(5) the value of [mm]×[rr]/[mr]² is 2.0 or less.

<11> The resin composition according to any one of the above <1> to <10>, wherein the fibers (C) are glass fibers.
<12> The resin composition according to any one of the above <1> to <10>, wherein the fibers (C) are carbon fibers.
<13> The resin composition according to any one of the above <1> to <12>, wherein the composition is a composition for injection molding.
<14> A molded article, which is formed of the resin composition of any one of the above <1> to <13>.
<15> An injection-molded article, which is formed of the resin composition of any one of the above <1> to <13>.

### Advantageous Effects of Invention

The resin composition and a molded article thereof are excellent in flowability and mold transferability and in appearance.

### DESCRIPTION OF EMBODIMENTS

The present invention is described hereinunder. In this description, the “component (a)” and the “olefinic polymer (A)” have the same meaning, the “component (b)” and the “olefinic polymer (B)” have the same meaning, and the “component (c)” and the “fibers (C)” have the same meaning. Also in this description, the numerical range expressed by the wording “a number A to another number B” means a range of “A or more and B or less” (in the case of A<B), or a range of “A or less and B or more” (in the case of A>B). Also in this description, a combination of preferred embodiments is a more preferred embodiment.

### [Resin Composition]

The resin composition of the present invention contains (a) an olefinic polymer (A) having a melting endotherm (ΔH-D) of 0 J/g or more and 80 J/g or less, which is defined as the area of a peak observed on the highest temperature side in a melting endothermic curve obtained with a differential scanning calorimeter (DSC) by keeping a sample of the polymer in a nitrogen atmosphere at −10° C. for 5 minutes and then heating the sample at 10° C./min, and having a molecular weight distribution (Mw/Mn) of less than 3.0, (b) an olefinic polymer (B) having a melting point (Tm-D) of 100° C. or higher, which is defined as the peak top observed on the highest temperature side in a melting endothermic curve obtained with a differential scanning calorimeter (DSC) by keeping a sample of the polymer in a nitrogen atmosphere at −10° C. for 5 minutes and then heating the sample at 10° C./min, and (c) fibers (C) having an aspect ratio of 10 or more and a mean fiber diameter of 0.01 μm or more and 1,000 μm or less. The resin composition of the present invention is, while excellent in stiffness and heat resistance, excellent in flowability and mold transferability, and is excellent in appearance, and is therefore favorable for injection molding.

The total content of the components (a) to (c) in the resin composition of the present invention is preferably 80% by mass or more, more preferably 90% by mass or more, even more preferably 95% by mass or more, and especially preferably 100% by mass or more, relative to 100% by mass of the resin composition. As described below, the resin composition of the present invention may contain, as needed, any components, such as additives and the like, other than the components (a) to (c).

### <Olefinic Polymer (A)>

The olefinic polymer (A) that is the component (a) for use in the present invention has a melting endotherm (ΔH-D) of 0 J/g or more and 80 J/g or less, which is obtained from a melting endothermic curve obtained with a differential scanning calorimeter (DSC) by keeping a sample at −10° C. for 5 minutes in a nitrogen atmosphere and then heating the sample at 10° C./min, and has a molecular weight distribution (Mw/Mn) of less than 3.0.

When the olefinic polymer (A) is blended in the olefinic polymer (B), the melting point of the olefinic polymer (B) can be maintained as such. In addition, the olefinic polymer (A) has high miscibility with the olefinic polymer (B) and therefore does not cause phase separation. Consequently, the olefinic polymer (A) can dissolve with the olefinic polymer (B) to retard the crystallization speed, and the flowability of the resin composition can be thereby improved. In addition, since the olefinic polymer (A) dissolves with the olefinic polymer (B), the dispersibility of the fibers (C) can be improved to prevent the fibers (C) from protruding out of surfaces, thereby improving the appearance of molded articles.

The olefinic polymer (A) is preferably an olefinic polymer produced by polymerization of one or more monomers selected from ethylene and α-olefins having 3 to 28 carbon atoms.

Examples of the α-olefins having 3 to 28 carbon atoms include propylene, 1-butene, 1-pentene, 4-methyl-1-pentene, 1-hexene, 1-octene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosene, etc. Among these, α-olefins having 3 to 24 carbon atoms are preferred, α-olefins having 3 to 12 carbon atoms are more preferred, α-olefins having 3 to 6 carbon atoms are even more preferred, α-olefins having 3 to 4 carbon atoms are especially preferred, and propylene is most preferred.

Regarding the olefinic polymer (A), an olefinic polymer produced by polymerization of one kind of these monomers may be used, or an olefinic copolymer produced by copolymerization of two or more thereof in combination may be used. In this description, a mere expression “olefinic polymer” includes an olefinic copolymer. The olefinic copolymer includes an ethylenic polymer in which an ethylene monomer accounts for 50 mol % or more of monomers constituting the polymer, a propylenic polymer (a1) in which a propylene monomer accounts for 50 mol % or more of monomers constituting the polymer, a butenic polymer in which a butene monomer accounts for 50 mol % or more of monomers constituting the polymer.

In the case where the olefinic polymer (B) of a main component is a propylenic polymer, the olefinic polymer (A) is, from the viewpoint of the miscibility thereof with the propylenic polymer of the main component, preferably a propylenic polymer, more preferably a propylenic polymer (a1).

The propylenic polymer (a1) is preferably a propylenic polymer selected from a propylene homopolymer, a propylene-ethylene block copolymer, a propylene-butene block copolymer, a propylene-α-olefin block copolymer, a propylene-ethylene random copolymer, a propylene-butene random copolymer, a propylene-α-olefin random copolymer and a propylene-α-olefin graft copolymer, etc., and is especially preferably a propylene homopolymer or a propylene-ethylene block copolymer.

With respect to the resin composition of the present invention where the olefinic polymer (B) of a main component is a propylenic polymer, in the case where the propylenic polymer (a1) is a copolymer that contains an olefin having 2 carbon atoms, the content of the structural unit of the olefin having 2 carbon atoms (namely, ethylene monomer) therein is, from the viewpoint of the miscibility of the copolymer with the main component of the propylenic polymer, preferably more than 0 mol % and 20 mol % or less, more preferably more than 0 mol % and 18 mol % or less, even more preferably more than 0 mol % and 15 mol % or less, further more preferably more than 0 mol % and 13 mol % or less. In the case of a copolymer that contains an olefin having 3 carbon atoms, the content of the structural unit of the olefin having 3 carbon atoms (namely, propylene monomer) is preferably 50 mol % or more, more preferably 65 mol % or more, even more preferably 75 mol % or more, further more preferably 80 mol % or more. In the case of a copolymer that contains an α-olefin having 4 or more carbon atoms, the content of the structural unit of the α-olefin having 4 or more carbon atoms is preferably more than 0 mol % and 30 mol % or less, more preferably more than 0 mol % and 27 mol % or less, even more preferably more than 0 mol % and 20 mol % or less.

In the case where the propylenic polymer (a1) is a copolymer, the copolymer preferably satisfies at least one of the following (i) and (ii):

(i) An ethylene structural unit is contained in an amount of more than 0 mol % and 20 mol % or less.

(ii) A 1-butene structural unit is contained in an amount of more than 0 mol % and 30 mol % or less.

In the resin composition of the present invention where the olefinic polymer (B) of a main component is a propylenic polymer, the olefinic polymer (A) is, from the viewpoint of the miscibility thereof with the main component of the propylenic polymer, most preferably a propylene homopolymer. The polymer may be a polymer using a petroleum-derived or coal-derived monomer, or may be a polymer using a biomass-derived monomer.

The content of the olefinic polymer (A) in the resin composition of the present invention is, from the viewpoint of maintaining the heat resistance of the resin composition, preferably less than 50% by mass, more preferably 30% by mass or less, even more preferably 25% by mass or less, further more preferably 20% by mass or less, and is preferably 0.5% by mass or more, more preferably 1% by mass or more, even more preferably 2% by mass or more, and further more preferably 2.5% by mass or more, relative to the total content 100% by mass of the olefinic polymer (A) and the olefinic polymer (B).

In particular, when the olefinic polymer (A) is a propylenic polymer (a1) and the olefinic polymer (B) is a propylenic polymer, the miscibility of the propylenic polymer with the propylenic polymer (a1) is better, and a molded article excellent in appearance can be obtained.

From the viewpoint of greatly improving the flowability and the mold transferability of the resin composition without having any negative influence on the mechanical properties of the resin composition, the olefinic polymer (A) has the following melting endotherm (ΔH-D) and molecular weight distribution (Mw/Mn), and preferably has the following properties.

### (Melting Endotherm (ΔH-D))

The melting endotherm (ΔH-D) of the olefinic polymer (A) is 0 J/g or more and 80 J/g or less. In the case where the melting endotherm (ΔH-D) of the olefinic polymer (A) falls within the range, the degree of crystallization of the olefinic polymer (B) (especially in the case where the olefinic polymer (B) is a propylenic polymer (b1)), which is a main component of the resin composition of the present invention, can be decreased to improve the flowability thereof while maintaining the melting point of the olefinic polymer (B) as such. From this viewpoint, the melting endotherm (ΔH-D) is preferably 10 J/g or more, more preferably 20 J/g or more, even more preferably 30 J/g or more, and is preferably 70 J/g or less, more preferably 60 J/g or less, even more preferably 50 J/g or less.

The melting endotherm (ΔH-D) can be controlled by appropriately controlling the monomer concentration and the reaction pressure.

The melting endotherm (ΔH-D) is determined by calculating the area surrounded by a line portion containing a peak observed on the highest temperature side of the melting endothermic curve of the polymer in DSC, and a baseline drawn by connecting a point on a low-temperature side where no change of the quantity of heat is present with a point on a high-temperature side where no change of the quantity of heat is present.

### (Molecular Weight Distribution (Mw/Mn))

The molecular weight distribution (Mw/Mn) of the olefinic polymer (A) is, from the viewpoint of high strength, preferably less than 3.0. When the molecular weight distribution (Mw/Mn) is less than 3.0, the influence on the mechanical properties of the resin composition may be low. From this viewpoint, the molecular weight distribution (Mw/Mn) of the olefinic polymer (A) is preferably 2.5 or less, more preferably 2.2 or less, and is preferably 1.2 or more, more preferably 1.5 or more.

In the present invention, the molecular weight distribution (Mw/Mn) is a value calculated from the weight average molecular weight Mw and the number average molecular weight Mn in terms of polystyrene measured according to gel permeation chromatography (GPC).

The olefinic polymer (A) and the propylenic polymer (a1) are preferably propylenic polymers satisfying any one or both of the following (1) and (2), more preferably satisfying the following (3), and even more preferably satisfying the following (4) and (5).

(1) The meso pentad fraction is 20 mol % or more and 60 mol % or less.

(2) The melting point (Tm-D), which is defined as the peak top observed on the highest temperature side in a melting endothermic curve obtained with a differential scanning calorimeter (DSC) by keeping a sample in a nitrogen atmosphere at −10° C. for 5 minutes and then heating the sample at 10° C./min, is 0° C. or higher and 120° C. or lower.

(3) The value of [rrrr]/(1−[mmmm]) is 0.1 or less.

(4) The racemic meso racemic meso pentad fraction [rmrm] is more than 2.5 mol %.

(5) The value of [mm]×[rr]/[mr]² is 2.0 or less.

### (1) Meso Pentad Fraction [Mmmm]

The meso pentad fraction [mmmm] is an index of indicating the stereoregularity of the olefinic polymer (A) and the propylenic polymer (a1), and with the increase in the meso pentad fraction [mmmm] thereof, the stereoregularity of the polymer increases.

In the case where the olefinic polymer (A) is a propylene homopolymer, the meso pentad fraction [mmmm] thereof is, from the viewpoint of the handleability of the propylenic polymer and of the improving effect for retarding the crystallization speed of the propylenic polymer when a small amount of the polymer is added to the olefinic polymer (B), preferably 20% or more, more preferably 25% or more, even more preferably 30 mol % or more, and is preferably 60 mol % or less, more preferably 57.5 mol % or less, even more preferably 55 mol % or less. When the meso pentad fraction [mmmm] is 20 mol % or more, the resin composition of the present invention may be given flowability without tackifying the olefinic polymer (A) of a main component, and when the meso pentad fraction [mmmm] is 60 mol % or less, the polymer does not form an eutectic mixture with the olefinic polymer (B) of a main component but can dissolve in the amorphous part of the olefinic polymer (B) of a main component.

### (2) Melting Point (Tm-D)

The melting point (Tm-D) of the olefinic polymer (A) and the propylenic polymer (a1) is preferably high from the viewpoint of strength and moldability. Preferably, the melting point is 0° C. or higher, more preferably 50° C. or higher, even more preferably 55° C. or higher, further more preferably 60° C. or higher, and is preferably 120° C. or lower, more preferably 100° C. or lower, even more preferably 90° C. or lower, and further more preferably 80° C. or lower.

In the present invention, the peak top of a peak observed on the highest temperature side in a melting endothermic curve obtained with a differential scanning calorimeter (manufactured by PerkinElmer Co., Ltd., DSC-7) by keeping 10 mg of a sample in a nitrogen atmosphere at −10° C. for 5 minutes and then heating the sample at 10° C./min is defined as the melting point (Tm-D). The melting point (Tm-D) can be controlled by appropriately controlling the monomer concentration or the reaction pressure.

(3) [rrrr]/(1−[mmmm])

The value of [rrrr]/(1−[mmmm]) can be obtained from the meso pentad fraction [mmmm] and the racemic pentad fraction [rrrr], and is an index of indicating regularity distribution evenness of polypropylene. One having a large value of [rrrr]/(1−[mmmm]) is a mixture of a high-stereoregularity polypropylene and an atactic polypropylene such as a conventional polypropylene produced using an already-existing catalyst system, and causing stickiness of the polypropylene molded article after molding. The unit of [rrrr] and [mmmm] in the above is mol %.

The value of [rrrr]/(1−[mmmm]) of the olefinic polymer (A) and the propylenic polymer (a1) is, from the viewpoint of stickiness, preferably 0.1 or less, more preferably 0.05 or less, even more preferably 0.04 or less. The lower limit is, though not specifically limited thereto, preferably 0.001 or more, more preferably 0.01 or more.

Here, the meso pentad fraction [mmmm] and the racemic pentad fraction [rrrr], and the racemic meso racemic meso pentad fraction [rmrm] to be mentioned below are determined in accordance with the method proposed in “Macromolecules, 6, 925 (1973)” by A. Zambelli et al., and are a meso fraction, a racemic fraction and a racemic meso racemic meso fraction in a pentad unit in a polypropylene molecular chain measured with the signal of a methyl group in the ¹³C-NMR spectrum thereof. When the meso pentad fraction [mmmm] is large, the stereoregularity increases. The triad fractions [mm], [rr] and [mr] to be mentioned below are also calculated according to the above-mentioned method.

### (4) Racemic Meso Racemic Meso Pentad Fraction [Rmrm]

The racemic meso racemic meso pentad fraction [rmrm] is an index of indicating the stereoregularity randomness of polypropylene, and a larger value thereof indicates increase in randomness of polypropylene.

The racemic meso racemic meso pentad fraction [rmrm] of the olefinic polymer (A) and the propylenic polymer (a1) is preferably more than 2.5 mol %. When [rmrm] of the olefinic polymer (A) and the propylenic polymer (a1) is more than 2.5 mol %, the randomness increases, and the polymer may hardly form an eutectic mixture with the olefinic polymer (B) of a main component of the resin composition of the present invention (especially in the case where the olefinic polymer (B) is a propylenic polymer) and, as a result, the heat resistance and the stiffness of the resin composition can be prevented from lowering. From this viewpoint, the racemic meso racemic meso pentad fraction [rmrm] of the olefinic polymer (A) and the propylenic polymer (a1) is preferably 2.6 mol % or more, more preferably 2.7 mol % or more. The upper limit is generally 10 mol % or so, and the racemic meso racemic meso pentad fraction [rmrm] is more preferably 7 mol % or less, even more preferably 5 mol % or less, further more preferably 4 mol % or less.

(5) [mm]×[rr]/[mr]²

The value of [mm]×[rr]/[mr]² that is calculated from the triad fractions [mm], [rr] and [mr] indicates an index of the randomness of a polymer, and when the value is nearer to 1, the randomness of the polymer is higher. The polymer of the case does not form an eutectic mixture with the olefinic polymer of a main component of the resin composition of the present invention (especially in the case where the olefinic polymer (B) is a propylenic polymer), and therefore can efficiently increase the amorphous fraction of the olefinic polymer (B) (especially the propylenic polymer) of a main component. The value of the olefinic polymer (A) and the propylenic polymer (a1) is generally 2.0 or less, preferably 1.8 or less, more preferably 1.6 or less. The lower limit is, though not limited thereto, preferably 0.5 or more. The unit of [mm] and [rr] in the above is mol %.

### (Weight Average Molecular Weight (Mw))

The weight average molecular weight (Mw) of the olefinic polymer (A) is, from the viewpoint of strength, preferably 10,000 or more, more preferably 20,000 or more, even more preferably 30,000 or more, and is preferably 500,000 or less, more preferably 200,000 or less, even more preferably 100,000 or less. When the weight average molecular weight of the olefinic polymer (A) falls within the above range, the resin composition of the present invention can be given flowability without lowering the stiffness of the olefinic polymer (B) of a main component of the resin composition.

In the present invention, the weight average molecular weight (Mw) is a weight average molecular weight in terms of polystyrene measured according to a method of gel permeation chromatography (GPC).

The olefinic polymer (A) may be produced, for example, using a metallocene catalyst as described in WO 2003/087172. In particular, a transition metal compound in which the ligand forms a crosslinked structure via a crosslinking group is preferably used, and above all, a metallocene catalyst obtained by combining a transition metal compound having a crosslinked structure via two crosslinking groups and a cocatalyst is preferred.

Specifically, examples thereof include a polymerization catalyst containing (i) a transition metal compound represented by the following general formula (I) and (ii) a component selected from (ii-1) a compound capable of reacting with the transition metal compound that is the component (i) or a derivative thereof to form an ionic complex and (ii-2) an aluminoxane.

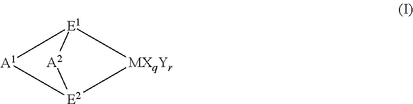

In the formula, M represents a metal element belonging to any one of the Groups 3 to 10 or the lanthanoid series in the periodic table; E¹ and E² each represent a ligand selected from a substituted cyclopentadienyl group, an indenyl group, a substituted indenyl group, a heterocyclopentadienyl group, a substituted heterocyclopentadienyl group, an amide group, a phosphide group, a hydrocarbon group, and a silicon-containing group, and form a crosslinked structure via A¹ and A², and E¹ and E² may be the same as or different from each other; X represents a 6-bonding ligand, and when plural X's are present, plural X's may be the same as or different from each other, and X may crosslink with any other X, E¹, E², or Y; Y represents a Lewis base, and when plural Y's are present, plural Y's may be the same as or different from each other, and Y may crosslink with any other Y, E¹, E², or X; A¹ and A² each represent a divalent crosslinking group that bonds two ligands and represents a hydrocarbon group having 1 to 20 carbon atoms, a halogen-containing hydrocarbon group having 1 to 20 carbon atoms, a silicon-containing group, a germanium-containing group, a tin-containing group, —O—, —CO—, —S—, —SO₂—, —Se—, —NR¹—, —PR¹—, —P(O)R¹—, —BR¹—, or —AlR¹—, wherein R¹ represents a hydrogen atom, a halogen atom, a hydrocarbon group having 1 to 20 carbon atoms, or a halogen-containing hydrocarbon group having 1 to 20 carbon atoms, and may be the same as or different from each other; q represents an integer of 1 to 5 and corresponds to [(valence of M)−2]; and r represents an integer of 0 to 3.

The transition metal compound that is the component (i) is preferably a transition metal compound in which the ligand is of a (1,2′)(2,1′) double crosslinking type, and examples thereof include (1,2′-dimethylsilylene)(2,1′-dimethylsilylene)-bis(3-trimethylsilylmethylindenyl)zirconium dichloride.

As specific examples of the compound that is the component (ii-1), there can be exemplified triethylammonium tetraphenylborate, tri-n-butylammonium tetraphenylborate, trimethylammonium tetraphenylborate, tetraethylammonium tetraphenylborate, methyl(tri-n-butyl)ammonium tetraphenylborate, benzyl(tri-n-butyl)ammonium tetraphenylborate, dimethyldiphenylammonium tetraphenylborate, triphenyl(methyl)ammonium tetraphenylborate, trimethylanilinium tetraphenylborate, methylpyridinium tetraphenylborate, benzylpyridinium tetraphenylborate, methyl(2-cyanopyridinium) tetraphenylborate, triethylammonium tetrakis(pentafluorophenyl)borate, tri-n-butylammonium tetrakis(pentafluorophenyl)borate, triphenylammonium tetrakis(pentafluorophenyl)borate, tetra-n-butylammonium tetrakis(pentafluorophenyl)borate, tetraethylammonium tetrakis(pentafluorophenyl)borate, benzyl(tri-n-butyl)ammonium tetrakis(pentafluorophenyl)borate, methyl diphenylammonium tetrakis(pentafluorophenyl)borate, triphenyl(methyl)ammonium tetrakis(pentafluorophenyl)borate, methylanilinium tetrakis(pentafluorophenyl)borate, dimethylanilinium tetrakis(pentafluorophenyl)borate, trimethylanilinium tetrakis(pentafluorophenyl)borate, methylpyridinium tetrakis(pentafluorophenyl)borate, benzylpyridinium tetrakis(pentafluorophenyl)borate, methyl(2-cyanopyridinium) tetrakis(pentafluorophenyl)borate, benzyl(2-cyanopyridinium) tetrakis(pentafluorophenyl)borate, methyl(4-cyanopyridinium) tetrakis(pentafluorophenyl)borate, triphenylphosphonium tetrakis(pentafluorophenyl)borate, dimethylanilinium tetrakis[bis(3,5-ditrifluoromethyl)phenyl]borate, ferrocenium tetraphenylborate, silver tetraphenylborate, trityl tetraphenylborate, tetraphenylporphyrinmanganese tetraphenylborate, ferrocenium tetrakis(pentafluorophenyl)borate, (1,1′-dimethylferrocenium) tetrakis(pentafluorophenyl)borate, decamethylferrocenium tetrakis(pentafluorophenyl)borate, silver tetrakis(pentafluorophenyl)borate, trityl tetrakis(pentafluorophenyl)borate, lithium tetrakis(pentafluorophenyl)borate, sodium tetrakis(pentafluorophenyl)borate, tetraphenylporphyrinmanganese tetrakis(pentafluorophenyl)borate, silver tetrafluoroborate, silver hexafluorophosphate, silver hexafluoroarsenate, sliver perchlorate, silver trifluoroaceate, silver trifluoromethanesulfonate.

Examples of the aluminoxane that is the component (ii-2) include known chain aluminoxanes and cyclic aluminoxanes.

In addition, the olefinic polymer (A) may also be produced by jointly using an organoaluminum compound, such as trimethylaluminum, triethylaluminum, triisopropylaluminum, triisobutylaluminum, dimethylaluminum chloride, diethylaluminum chloride, methylaluminum dichloride, ethylaluminum dichloride, dimethylaluminum fluoride, diisobutylaluminum hydride, diethylaluminum hydride, ethylaluminum sesquichloride.

### <Olefinic Polymer (B)>

Regarding the olefinic polymer (B) of the component (b) for use in the present invention, the melting point (Tm-D) thereof, which is defined as the peak top observed on the highest temperature side in a melting endothermic curve obtained with a differential scanning calorimeter (DSC) by keeping a sample in a nitrogen atmosphere at −10° C. for 5 minutes and then heating the sample at 10° C./min, is 100° C. or higher.

When the melting point (Tm-D) is lower than 100° C., there may occur a disadvantage that the heat resistance of the resin composition worsens. From this viewpoint, the melting point (Tm-D) is preferably 120° C. or higher, more preferably 140° C. or higher, even more preferably 150° C. or higher, and further more preferably 160° C. or higher.

The melting point (Tm-D) is a value measured according to the method described in the section of Examples given hereunder.

The olefinic polymer (B) is preferably an olefinic polymer to be produced by polymerization of one or more kinds of monomers selected from ethylene and α-olefins having 3 to 28 carbon atoms.

Examples of the α-olefins having 3 to 28 carbon atoms include propylene, 1-butene, 1-pentene, 4-methyl-1-pentene, 1-hexene, 1-octene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosene. Among those, α-olefins having 3 to 24 carbon atoms are preferred; α-olefins having 3 to 12 carbon atoms are more preferred; α-olefins having 3 to 6 carbon atoms are still more preferred; α-olefins having 3 to 4 carbon atoms are especially preferred; and propylene is most preferred.

As the olefinic polymer (B), an olefinic polymer obtained by polymerization of one kind of these monomers may be used, and an olefinic copolymer obtained by copolymerization of two or more thereof may be used. Examples of the olefinic polymer include an ethylenic polymer in which an ethylene monomer accounts for 50 mol % or more of monomers constituting the polymer; a propylenic polymer (b1) in which a propylene monomer accounts for 50 mol % or more of monomers constituting the polymer; a butenic polymer in which a butene monomer accounts for 50 mol % or more of monomers constituting the polymer. The olefinic polymer (B) is preferably a propylenic polymer from the viewpoint of high heat resistance, high toughness, low density and chemical resistance.

The propylenic polymer (b1) is preferably a propylenic polymer selected from a propylene homopolymer, a propylene-ethylene block copolymer, a propylene-butene block copolymer, a propylene-α-olefin block copolymer, a propylene-ethylene random copolymer, a propylene-butene random copolymer, a propylene-α-olefin random copolymer and a propylene-α-olefin graft copolymer, etc., and is more preferably a propylene-ethylene block copolymer or a propylene homopolymer. The polymer may also be a polymer using a petroleum-derived or coal-derived monomer, or may be a polymer using a biomass-derived monomer.

From the viewpoint of heat resistance of the resin composition, the meso pentad fraction [mmmm] of the propylene polymer (b1) is preferably 70 mol % or more, more preferably 80 mol % or more, even more preferably 85 mol % or more, further more preferably 87 mol % or more and still further more preferably 90 mol % or more, and is preferably 99.5 mol % or less, more preferably 99 mol % or less, even more preferably 98 mol % or less, further more preferably 97 mol % or less.

The content of the olefinic polymer (B) in the resin composition of the present invention is, from the viewpoint of heat resistance of the resin composition, preferably 50% by mass or more relative to the total content, 100% by mass of the olefinic polymer (A) and the olefinic polymer (B), more preferably 80% by mass or more, even more preferably 85% by mass or more, further more preferably 90% by mass or more, and is preferably 99.5% by mass or less, more preferably 99% by mass or less, even more preferably 98% by mass or less, and further more preferably 97.5% by mass or less.

### <Fibers (C)>

Regarding the fibers (C) of the component (c) for use in the present invention, the aspect ratio thereof is 10 or more and the mean fiber diameter thereof is 0.01 μm or more and 1,000 μm or less from the viewpoint of improving the mechanical strength of resin.

The aspect ratio is preferably 50 or more, more preferably 100 or more, even more preferably 500 or more. The mean fiber diameter is preferably 0.1 μm or more, more preferably 1 μm or more, and is preferably 700 μm or less, more preferably 500 μm or less, even more preferably 200 μm or less.

The fibers may be in any form of milled fibers or chopped strands, and may be continuous fibers. Here, the aspect ratio is a ratio of the mean fiber length of fibers to the mean fiber diameter of fibers.

Methods for measuring the mean fiber diameter and the mean fiber length are not specifically limited, and examples thereof include a method of measurement through microscopic observation of the surface of the resin composition, a method of measurement through microscopic observation of fibers using a solvent that dissolves the matrix resin alone of the resin composition followed by collecting the remaining fibers through filtration (dissolution method), etc. In the case where a solvent capable of dissolving the matrix resin alone is unavailable, a method (firing-off method) where the matrix resin alone is fired off in a temperature range not causing oxidation loss of fibers to thereby separate and collect fibers and the fibers are analyzed through microscopic observation and the like may be employable. For the measurement, the fibers are randomly selected, and the length thereof is measured up to a unit of 0.1 μm using a microscope, and the fiber length and the proportion thereof can be thus determined. For the microscopic observation, a scanning electron microscope or a transmission electron microscope may be used, or by statistical analysis of the observed images, the data may be obtained. For the mean fiber diameter, the diameter of each fiber is measured when the cross section thereof is circular, but in other cases (for example, oval, flattened, etc.), the longest side of the cross section is measured to determine the mean fiber diameter.

Fibers may be previously cut. Examples of the cutting method include, though not specifically limited thereto, a method using a cartridge cutter, a method using a guillotine cutter, etc., and the cutting method may be appropriately selected in consideration of dimensional accuracy, workability, productivity, etc.

Specific examples of the fibers include organic fibers such as polyolefin fibers (e.g., ultra-high-molecular-weight polyethylene fibers), polyamide fibers (e.g., aramid fibers), polyester fibers (e.g., fully-aromatic polyester fibers), polyparaphenylene-benzobisoxazole fibers, LCP (liquid-crystal polymer) fibers, cellulose nanofibers and carbon fibers; and inorganic fibers such as glass fibers, boron fibers, metal fibers of aluminum, brass, stainless or the like, and ceramic fibers of alumina, silicon carbide or the like. One of these may be used singly or two or more thereof may be used in combination. Among these, carbon fibers and glass fibers are preferred from the viewpoint of the stiffness and the economic potential of the resin composition, and glass fibers are especially preferred.

Commercial products of ultra-high-molecular-weight polyethylene fibers include “Dyneema” (trade name by Toyobo Co., Ltd.); “Dyneema” (trade name by DSM Corp.); “Spectra” (trade name by Honeywell International Inc.).

Polyamide fibers include polyparaphenylene-terephthalamide fibers (e.g., “Kevlar”, trade name by DuPont-Toray Co., Ltd.), copolyparaphenylene-3,4′-diphenylether-terephthalamide fibers (e.g., “Technora”, trade name by Teijin Limited).

Commercial products of fully-aromatic polyester fibers include “Vectran” (trade name by Kuraray Co., Ltd.).

Commercial products of polyparaphenylene-benzobisoxazole fibers include “Zylon” (trade name by Toyobo Co., Ltd.).

Examples of carbon fibers include polyacrylonitrile (PAN)-based, pitch-based, lignin-based and rayon-based carbon fibers. Versatile and inexpensive and having a high strength, use of PAN-based or pitch-based carbon fibers is preferred.

Generally, carbon fibers are used in the form of a bundle of filaments of carbon fibers. The number of filaments is generally 1,000 or more and 100,000 or less. From the viewpoint of handleability and openability of carbon fibers, the number is preferably 1,000 or more, more preferably 2,000 or more, and is preferably 50,000 or less, more preferably 25,000 or less. The diameter of the carbon fiber (filament) is preferably 1 μm or more, more preferably 2 μm or more, and is preferably 100 μm or less, more preferably 50 μm or less. Carbon fibers may be processed with a sizing agent. Preferably, fiber bundles are previously opened using air, rollers or the like so as to make resin penetrate between the filaments of carbon fibers.

As glass fibers, E-glass or S-glass fibers are preferably used. The mean fiber diameter of glass fibers is preferably 1 μm or more, and is preferably 500 μm or less, more preferably 100 μm or less. When the mean fiber diameter is less than 1 μm, glass fibers could hardly fit with resin so that resin infiltration thereinto would be difficult, but on the other hand, when the mean fiber diameter is more than 500 μm, fibers would readily cut or break during melt kneading.

As a coupling agent, any can be appropriately selected from those heretofore known as so-called silane coupling agents and titanium coupling agents. For example, aminosilanes and epoxysilanes such as γ-aminopropyltrimethoxysilane, N-β-(aminoethyl)-γ-aminopropyltrimethoxysilane, γ-glycidoxypropyltriethoxysilane, β-(3,4-epoxycyclohexyl)ethyltrimethoxysilane and the like are employable. In particular, use of the foregoing aminosilane compounds is preferred.

As a bundling agent, for example, urethane-based, olefinic, acrylic, butadiene-based and epoxy-based agents and the like are employable, and among these, urethane-based and olefinic agents are preferred.

As the glass fibers, resin-coated glass fibers prepared by coating glass fibers with the above-mentioned olefinic polymer (B) may also be used. The resin-coated glass fibers are glass fibers previously coated with the olefinic polymer (B), and correspond to a so-called glass fiber-reinforced resin. Generally, the resin-coated glass fibers are ones produced by immersing roving glass fibers in the olefinic polymer (B) so as to be coated with the polymer and extruding them into strands using an extruder or the like, and thereafter cooling and pelletizing them. Consequently, the glass fibers have the same length as the pellets.

The surface of the fibers may be treated for modification for the purpose of increasing the affinity with a thermoplastic resin. The modification treatment is preferably acid modification, more preferably maleic acid modification treatment. For the maleic acid modification treatment, the surfaces of the fibers may be coated with a maleic acid-modified resin. The maleic acid-modified resin includes a maleic acid-grafted polyethylene, a maleic acid-grafted polypropylene and a maleic acid-grafted SEBS resin.

The content of the fibers (C) in the resin composition of the present invention is, from the viewpoint of heat resistance and stiffness of the resin composition, preferably 3 parts by mass or more, more preferably 5 parts of more, even more preferably 7 parts or more, further more preferably 10 parts or more, and is preferably 200 parts or less, more preferably 100 parts or less, even more preferably 70 parts or less, further more preferably 50 parts or less, relative to the total content 100 parts by mass of the olefinic polymer (A) and the olefinic polymer (B).

### <Additives>

In the resin composition of the present invention, as needed, a modified polyolefin, an antioxidant, a heat-resistant stabilizer, a weather-resistant stabilizer, an antistatic agent, a slipping agent, an antifogging agent, a lubricant, a nucleating agent, an antiblocking agent, a dye, a pigment, a natural oil, a synthetic oil, a wax, a filler, an elastomer and the like may be blended within a range not detracting from the object of the present invention.

By adding a modified polyolefin, the interfacial strength between the fibers and the olefinic polymer may be increased so that the stiffness of the molded article to be obtained is expected to increase. As the modified polyolefin, for example, at least one selected from a chlorinated polyolefin, an acid-modified polyolefin, a chlorinated acid-modified polyolefin and a silane-modified polyolefin may be used. Preferably, the modified polyolefin is blended within a range of 0.1% by mass or more and 20% by mass or less, relative to 100% by mass of the total amount of the resin composition.

As the base resin for the modified polyolefin, the above-mentioned olefinic polymer (B) may be used. In this case, preferably, the non-modified olefinic resin (B) and the base resin for the modified polyolefin to be contained in the resin composition of the present invention are of the same kind. In the case where they are of the same kind, preferably, the difference in the mean molecular weight, the density and the like between the two is smaller, and in the case of a copolymer, preferably, the difference in the proportion of each monomer unit is smaller.

The chlorinated polyolefin includes one produced by introducing chlorine into the olefinic polymer (B). In the present invention, the method for producing the chlorinated polyolefin is not specifically limited. For example, as a method for producing a chlorinated polyolefin except for an acid-modified chlorinated polyolefin, there may be mentioned a production method including dissolving a polyolefin in a chlorine-based solvent such as chloroform or the like and introducing chlorine thereinto. Chlorine introduction can be carried out by blowing a chlorine gas into the reaction system. Chlorine gas blowing may be carried out under exposure to UV rays, or may be carried out in the presence or absence of a radical reaction initiator. The pressure in chlorine gas blowing is not specifically limited, and may be an ordinary pressure or an increased pressure. The temperature in chloride gas blowing is not specifically limited, but is generally 50 to 140° C. After chlorine introduction into polyolefin, a chlorinated polyolefin can be obtained. The chlorine-based solvent in the system is generally evaporated away under reduced pressure or the like, or is purged with an organic solvent.

The acid-modified polyolefin includes one produced by introducing an acid group into the above-mentioned olefinic polymer (B). The method for acid group introduction is not specifically limited, for which, in general, so-called graft polymerization of reacting a polyolefin with a compound having an acid group may be employed. The compound having an acid group is not also specifically limited, including those having a carboxy group or a derivative thereof (anhydride, etc.) such as carboxylic acids and derivatives thereof, and also those having a sulfo group or a derivative thereof such as sulfonic acids and derivatives thereof (methanesulfonic acid, vinylsulfonic acid, trifluoromethylsulfonic acid, benzenesulfonic acid, p-toluenesulfonic acid, pentafluorobenzenesulfonic acid).

In the case of using a carboxylic acid, unsaturated carboxylic acids or derivatives thereof are more preferred since unsaturated carboxylic acids can be more readily added to polyolefinic resins than saturated carboxylic acids. Those having a carboxy group or a derivative thereof (anhydride, etc.) such as carboxylic acids and derivatives thereof include maleic anhydride, itaconic anhydride, succinic anhydride, glutaric anhydride, adipic anhydride, maleic acid, itaconic acid, fumaric acid, acrylic acid and methacrylic acid. One of these may be used singly or two or more thereof may be used in combination. Among these, acid anhydrides are used in many cases, and in particular, maleic anhydride and itaconic anhydride are frequently used.

The amount of the acid group introduced in the acid-modified polyolefin is not specifically limited, but the introduction amount is preferably one to give an acid value of 5 or more. When the introduction amount is one to make the acid-modified polyolefin have an acid value of 5 or more, the mechanical properties of molded articles can be sufficiently improved without blending a large amount of the acid-modified polyolefin in the composition. The acid value is more preferably 10 to 80, especially preferably 15 to 70, and further more preferably 20 to 60. The acid value may be measured according to JIS K0070.

The chlorinated acid-modified polyolefin includes one produced by introducing an acid group and chlorine into the above-mentioned olefinic polymer (B). The method for introducing an acid group and chlorine is not also specifically limited, for which, in general, there is mentioned a production method of reacting a polyolefin with a compound having an acid group to give an acid-modified polyolefin, then dissolving the acid-modified polyolefin in a chlorine-based solvent such as chloroform and thereafter blowing a chlorine gas thereinto so as to introduce chlorine into the acid-modified polyolefin. As the compound having an acid group and the chlorine introduction method, those mentioned hereinabove may be employed.

The silane-modified polyolefin includes one produced by introducing a silyl group into the above-mentioned olefinic polymer (B). The method for silyl group introduction is not also specifically limited, and generally, a polyolefin is reacted with an unsaturated silane compound for the introduction. Regarding the unsaturated silane compound, specific examples of monomers having a silyl group and an ethylenic unsaturated group include those represented by the following formula:

(RO)₃—Si—Y

wherein Y represents an ethylenic unsaturated group, R represents an alkyl group, and three R's may be the same as or different from each other.

The ethylenic unsaturated group has reactivity with the free radical moiety to form in polyolefin. Examples of the ethylenic unsaturated group include a vinyl group, an allyl group, a butenyl group, a cyclohexenyl group, a cyclopentadienyl group and a (meth)acryloxyalkyl group, and at least one selected from a vinyl group, a methacryloxyalkyl group and an acryloxyalkyl group is preferred.

The alkyl group may be linear or branched. The alkyl group is preferably one having 1 to 20 carbon atoms, more preferably 1 to 10 carbon atoms. Examples of the alkyl group include a methyl group, an ethyl group, a n-propyl group, an isopropyl group, various butyl groups, various pentyl groups, various hexyl group, various heptyl groups, various octyl groups, various nonyl groups and various decanyl groups, and among these, at least one selected from a methyl group and an ethyl group is preferred.

Specific examples of the unsaturated silane compound include vinyltriethoxysilane, vinyltrimethoxysilane, methacryloxypropyltrimethoxysilane and methacryloxypropyltriethoxysilane.

The amount of the unsaturated silane compound to be used is not specifically limited, but is, for example, preferably 0.1 to 50 parts by mass, more preferably 0.5 to 10 parts by mass, relative to 100 parts by mass of the olefinic polymer.

As the method of reacting the above-mentioned olefinic polymer (B) with a radical initiator and an unsaturated silane compound, a method of reacting them by melt kneading at a temperature of 100 to 300° C. or so using a roll mill, a Banbury mixer, an extruder or the like; or a method of reacting them in a mode of solution modification at a temperature of −50 to 300° C. or so, in an appropriate organic solvent such as a hydrocarbon solvent such as butane, pentane, hexane, heptane, cyclohexane, toluene, xylene and decahydronaphthalane; a halogenohydrocarbon solvent such as chlorobenzene, dichlorobenzene and trichlorobenzene; a liquefied α-olefin or the like may be employed.

As the antioxidant, a hindered phenol-based, sulfur-based, lactone-based, organic phosphite-based or organic phosphonite antioxidant, an antioxidant prepared by combining a few kinds of these or the like may be used. Preferably, the antioxidant is blended in an amount falling within a range of 0.01 to 5% by mass relative to 100% by mass of the total amount of the resin composition.

As the antistatic agent, generally usable, known low-molecular or high-molecular antistatic agents may be favorably used.

Examples of low-molecular antistatic agents include antistatic agents such as nonionic antistatic agents such as alkyldiethanolamines, polyoxyethylene alkylamides, monoglycerin fatty acid esters, diglycerin fatty acid esters and sorbitan fatty acid esters; tetraalkylammonium salt-based cationic antistatic agents; anionic antistatic agents such as alkylsulfonates; ampholytic antistatic agents such as alkylbetaines.

Examples of high-molecular antistatic agents include nonionic antistatic agents such as polyether ester amides; anionic antistatic agents such as polystyrenesulfonic acids; cationic antistatic agents such as quaternary ammonium salt-containing polymers; and others.

Preferably, the antistatic agent is blended in an amount falling within a range of 0.01 to 5% by mass relative to 100% by mass of the total amount of the resin composition.

The slipping agent usable herein includes amides of saturated or unsaturated fatty acids such as lauric acid, palmitic acid, oleic acid, stearic acid, erucic acid and behenic acid; or bisimides of these saturated or unsaturated fatty acids. Among these, erucic acid amide and ethylenebis-stearic acid amide are preferred. Preferably, the slipping agent is blended in an amount falling within a range of 0.01 to 5% by mass relative to 100% by mass of the total amount of the resin composition.

The antiblocking agent includes a fine powder silica, a fine powder aluminum oxide, a fine powder clay, a fine powder or liquid silicone resin, a polytetrafluoroethylene resin, and a fine powder crosslinked resin such as a crosslinked acrylic resin or methacrylic resin powder. Among these, a fine powder silica and a fine powder crosslinked resin are preferred. Preferably, antiblocking agent is blended in an amount falling within a range of 0.01 to 5% by mass relative to 100% by mass of the total amount of the resin composition.

As the elastomer, a styrene-based, olefin-based, ester-based, soft vinyl chloride-based, urethane-based, amide-based, butadiene-based or isoprene-based elastomer, or an elastomer mixture prepared by combining a few kinds of these may be used. Among these, a styrene-based, olefin-based, butadiene-based or isoprene-based elastomer is preferred. Preferably, the elastomer is blended in an amount is blended in an amount falling within a range of 1 to 20% by mass relative to 100% by mass of the total amount of the resin composition.

### <Production of Resin Composition>

The resin composition of the present invention may be produced by kneading the above-mentioned components (a), (b) and (c) and optionally the additives. For blending and kneading them, any ordinary instruments, for example, ordinary mixing and kneading machines such as a high-speed mixer, a Banbury mixer, a continuous kneader, a single-screw or twin-screw extruder, a roll, a Brabender Plastograph or the like may be used.

The resin composition of the present invention is favorably used for injection molding.

### <Molded Article>

The resin composition of the present invention can be molded into a molded article having a desired shape, according to a known molding method, for example, according to a method of injection molding, extrusion molding, blow molding, inflation molding, compression molding, vacuum forming. In particular, the resin composition is favorably used for producing injection-molded articles such as precision parts, large-size parts and cases.

The injection-molding method is not specifically limited, and any conventionally-known method (including an injection compression molding method, and a gas injection molding method) may be employed. For example, there are mentioned a method of putting a molding material into the heating cylinder of a molding machine, heating and melting it therein and then dispersing fibers and others, and thereafter feeding the resultant material to the forefront of the injection-molding machine, and injecting it out via a plunger or the like; a method of putting a molding material into the heating cylinder of a molding machine, heating and melting it therein, then feeding it toward the screw part of the injection-molding machine via a plunger or the like, dispersing fibers and others, and then injecting it out; and a method of feeding the resin composition toward the forefront part of an injection-molding machine using a deep-grooved screw having a small compression ratio and keeping the cylinder and others at an extremely high temperature while preventing breakage of fibers, and injection-molding the composition via a plunger or the like.

Examples of the use of the molded article produced by molding the resin composition of the present invention include:

housings for personal computers, displays, OA appliances, portable phones, personal digital assistances, facsimiles, compact discs, portable MDs, portable radio cassettes, PDA (personal digital assistances such as electronic notebooks), video cameras, digital video cameras, optical instruments, audios, air conditioners, lighting instruments, articles for relaxation, toys, other household electrical appliances;

electric or electronic instrument parts such as trays, laboratory dishes, interior members, or their cases;

parts for civil engineering or construction materials such as supporting posts, panels, reinforcing materials;

suspension, acceleration or steering members such as various members, various frames, various hinges, various arms, various wheels, bearings for various wheels, various beams, propeller shafts, wheels, gear boxes, etc.; exterior panel or body members such as hoods, roofs, doors, fenders, trunk lids, side panels, rear end panels, upper back panels, front bodies, under bodies, various pillars, various members, various frames, various beams, various supports, various rails, various hinges; exterior members such as bumpers, bumper beams, molds, undercovers, engine covers, current plates, spoilers, cowl louvers, aeroparts; interior members or motor members such as instrument panels, sheet frames, door trims, pillar trims, handles, various modules; automotive or two-wheeler structural parts for fuel-system, exhaust-system or inlet-system members and others, such as CNG tanks, gasoline tanks, fuel pumps, air intakes, intake manifolds, carburetor main bodies, carburetor spacers, various pipelines, various valves;

other automotive or two-wheeler members such as alternator terminals, alternator connectors, IC regulators, potentiometer bases for light dimmers, engine cooling water joints, thermostat bases for air conditioners, heating hot air flow control valves, brush holders for radiator motors, turbine vanes, wiper motor-related members, distributors, starter switches, starter relays, window washer nozzles, air conditioner panel switch base plates, coils for fuel-related electromagnetic valves, battery trays, AT brackets, head lamp supports, pedal housings, protectors, horn terminals, step motor rotors, lamp sockets, lamp reflectors, lamp housings, brake pistons, noise shields, spare tire covers, solenoid bobbins, engine oil filters, ignition cases, scuff plates, fasciae; and

aircraft members of landing gear pods, winglets, spoilers, edges, ladders, elevators, fairings, ribs.

From the viewpoint of mechanical properties, the molded article is favorably used for housings for electric or electronic instruments, civil engineering or construction material panels, automotive structural members, and aircraft members. In particular, from the viewpoint of mechanical properties and impact resistance, the molded article is favorably used for automotive or two-wheeler structural members.

The resin composition of the present invention is excellent in stiffness, heat resistance and mechanical strength and is also excellent in flowability and mold transferability. In addition, the resin composition of the present invention can prevent fibers from protruding out of surfaces, and therefore the molded article produced by molding the resin composition is excellent in appearance.

### EXAMPLES

Next, the present invention will be more specifically described with reference to Examples, but the present invention is by no means limited to these Examples.

### [DSC Measurement]

The melting endotherm (ΔH-D) was obtained from the melting endothermic curve obtained with a differential scanning calorimeter (DSC-7, available from Perkin Elmer, Inc.) by keeping 10 mg of a sample at −10° C. for 5 minutes in a nitrogen atmosphere and then heating the sample at 10° C./min. In addition, the melting point (Tm-D) was determined from the peak top of a peak observed on the highest temperature side of the resultant melting endothermic curve.

The melting endotherm (ΔH-D) is calculated by defining a line connecting a point on a low-temperature side where no change of the quantity of heat is present with a point on a high-temperature side where no change of the quantity of heat is present as a baseline and determining the area surrounded by a line portion containing a peak of the melting endothermic curve drawn in the DSC measurement with a differential scanning calorimeter (DSC-7, available from Perkin Elmer, Inc.) and the foregoing baseline.

### [Measurement of Weight Average Molecular Weight (Mw) and Molecular Weight Distribution (Mw/Mn)]

According to a method of gel permeation chromatography (GPC), the weight average molecular weight (Mw) and the number average molecular weight (Mn) were measured to determine the molecular weight distribution (Mw/Mn). For the measurement, the following device and conditions were used to obtain a weight average molecular weight and a number average molecular weight in terms of polystyrene. The molecular weight distribution (Mw/Mn) is a value calculated from these weight average molecular weight (Mw) and number average molecular weight (Mn).

### <GPC Measuring Device>

Column: TOSOH GMHHR-H(S)HT by Tosoh Corporation

Detector: RI detector for liquid chromatography, WATERS 150C, by Waters Corporation

### <Measurement Conditions>

Solvent: 1,2,4-trichlorobenzene

Measurement temperature: 145° C.

Flow rate: 1.0 mL/min

Sample concentration: 2.2 mg/mL

Injection amount: 160 μL

Calibration curve: Universal Calibration

Analysis program: HT-GPC (ver. 1.0)

### [NMR Measurement]

The ¹³C-NMR spectrum was measured with the following device under the following conditions. For the peak assignment, the method proposed by A. Zambelli, et al., “Macromolecules, Vol. 8, p. 687 (1975)” was referred to.

Device: ¹³C-NMR device, JNM-EX400 series, manufactured by JEOL, Ltd.

Method: Proton complete decoupling method

Concentration: 220 mg/mL

Solvent: Mixed solvent of 1,2,4-trichlorobenzene and deuterated benzene in a ratio of 90/10 (volume ratio)

Temperature: 130° C.

Pulse width: 45°

Pulse repetition time: 4 seconds

Accumulation: 10,000 times

### <Calculating Expressions>

M=m/S×100

R=γ/S×100

S=Pββ+Pαβ+Pαγ

S: Signal intensity of carbon atoms in side chain methyl of all the propylene units

Pββ: 19.8 to 22.5 ppm

Pαβ: 18.0 to 17.5 ppm

Pαγ: 17.5 to 17.1 ppm

γ: Racemic pentad chain, 20.7 to 20.3 ppm

m: Meso pentad chain, 21.7 to 22.5 ppm

The meso pentad fraction [mmmm], the racemic pentad fraction [rrrr], and the racemic meso racemic meso pentad fraction [rmrm] were measured in conformity with the method proposed by A. Zambelli, et al., “Macromolecules, 6, 925 (1973)” and are a meso fraction, a racemic fraction, and a racemic meso racemic meso fraction, respectively, in the pentad units of the polypropylene molecular chain that are measured based on the signal of the methyl group in the ¹³C-NMR spectrum. As the meso pentad fraction [mmmm] increases, the stereoregularity increases, too. In addition, the meso triad fraction [mm], the racemic triad fraction [rr], and the meso racemic triad fraction [mr] were also calculated by the above-described method.

### [Measurement of Melt Flow Rate (MFR)]

The melt flow rate was measured under conditions of a temperature of 230° C. and a load of 2.16 kg in conformity with JIS K7210.

### PRODUCTION EXAMPLES

### (Production of Propylene Polymer (A-1) and Propylene Polymer (A-2))

In a stirrer-equipped stainless steel-made reactor having an internal volume of 20 L, n-heptane, triisobutylaluminum, and further, a catalyst component obtained by previously bringing dimethylanilinium tetrakispentafluorophenylborate, (1,2′-dimethylsilylene)(2,1′-dimethylsilylene)-bis(3-trimethylsilylmethylindenyl)zirconium dichloride, triisobutylaluminum, and propylene into contact with each other in a mass ratio of 1/2/20 were continuously fed at 20 L/hr, 15 mmol/hr, and 6 μmol/hr in terms of zirconium, respectively.

Propylene and hydrogen were continuously fed to keep the whole pressure in the reactor at 1.0 MPa·G and the polymerization temperature was appropriately controlled so as to obtain a polymerization solution having a desired molecular weight.

An antioxidant was added to the resultant polymerization solution in such that the content thereof could be 1,000 ppm by mass, and then the solvent n-heptane was removed to give a propylene polymer (A-1) and a propylene polymer (A-2).

The propylene polymer (A-1) and the propylene polymer (A-2) produced in Production Examples were analyzed for the above-mentioned measurement. The results are shown in Table 1.

TABLE 1

| | | Propylene | Propylene |
|---|---|---|---|
| | | Polymer | Polymer |
| | Unit | (A-1) | (A-2) |
| Melting Point (Tm-D) | ° C. | 74 | 77 |
| Melting Endotherm (ΔH-D) | J/g | 38 | 40.4 |
| [mmmm] | mol % | 49.0 | 48.3 |
| [rrrr]/(1 − [mmmm]) | — | 0.038 | 0.039 |
| [rmrm] | mol % | 2.9 | 2.7 |
| [mm] × [rr]/[mr]² | — | 1.6 | 1.6 |
| Weight Average Molecular | — | 45,000 | 75,000 |
| Weight (Mw) | | | |
| Molecular Weight Distribution | — | 1.8 | 2.0 |
| (Mw/Mn) | | | |
| MFR | g/10 min | 2,000 | 350 |

### Examples 1 to 4 and Comparative Examples 1 to 2

The components shown in Table 2 were melt-kneaded at 230° C. using a twin-screw kneading extruder to prepare resin compositions. The raw materials used are as follows.

### <Glass Fibers-Containing Polypropylene>

“E7000”, trade name by Prime Polymer Co., Ltd.; content of glass fibers, 30% by mass; melting point (Tm-D), 162° C.; aspect ratio of fibers, 100; mean fiber diameter, 10 μm

### <Homopolypropylene>

“J-3000GV”, trade name by Prime Polymer Co., Ltd., melting point (Tm-D), 162° C.; melting endotherm (ΔH-D), 102 J/g; molecular weight distribution (Mw/Mn), 4.4

Using an injection molding machine (“EC100SX” by Toshiba Machine Co., Ltd.), the resultant resin composition was injection-molded at a molding temperature of 230° C., at a mold temperature of 45° C., under an injection pressure of 10 MPa and for an injection time of 30 seconds, thereby producing a molded article. The resultant molded article was subjected to the following measurements.

### (1) Tensile Test

Using a tensile tester (Model “ATM-P-S” by A&D Company, Limited) and according to JIS K7162, the molded article was tested for the tensile strength thereof under room-temperature conditions at an initial chuck-to-chuck distance of 115 mm and at a pulling rate of 50 mm/min, thereby determining the tensile breaking elongation and the tensile elastic modulus thereof.

### (2) Izod Impact Test

Using an Izod impact tester (Model “No. 158-ZA” by Yasuda Seiki Seisakusho, Ltd.) and according to JIS K7110, the molded article was subjected to an Izod impact test under room temperature conditions and under a hammer load of 2.75 J to determine the Izod impact value thereof.

### (3) Bending Test

Using a bending tester (Model “ABM-K” by A&D Company, Limited) and according to JIS K7203, the molded article was subjected to a bending test under room temperature conditions at a support-to-support distance of 60 mm, a support bed R of 2 mm, and an indenter R of 5 mm, thereby determining the bending strength and the bending elastic modulus thereof.

### (4) Heat Distortion Temperature

According to the measurement method ISO 75-1, 2, the heat distortion temperature (HDT) of a piece of the molded article having a thickness of 4 mm was measured under a load of 0.45 MPa. Samples having a higher heat distortion temperature have better heat resistance.

The flowability of the resin composition and the appearance of the molded article were evaluated as follows.

### (5) Flowability (Spiral Flow Test)

Using an Archimedes spiral flow mold (flow channel thickness 2 mm, flow channel width 10 mm), the resin composition was injection-molded at an injection temperature of 200° C., at a mold temperature of 30° C. and under an injection pressure of 80 MPa to determine the spiral flow length (SFL). Samples having a longer spiral flow length are more excellent in flowability.

### (6) Appearance of Molded Article

The surface of the molded article obtained in the above-mentioned spiral flow test was observed using a confocal laser scanning microscope (LSM, “OPTELICS H1200” by Lasertec Corporation) at an object lens magnification of 10 times, to measure the arithmetic mean height Sa (μm) that is an an index of the surface roughness thereof. Samples having a smaller value of the surface roughness Sa (μm) are more excellent in surface smoothness. The measurement was made at 3 points of 15 mm (A point) and 35 mm (B point) from the injection position (spiral center), and minus 10 mm (C point) from the end.

In general, the mold temperature is set low, and therefore, at a point remoter from the injection position, the resin composition solidifies more rapidly so that the mold transferability thereof worsens, and consequently the fibers contained in the resin composition protrude out more readily to the surface of the molded article to thereby increase the surface roughness.

TABLE 2

| | | | | | | | Comparative | Comparative |
|---|---|---|---|---|---|---|---|---|
| | | | Example 1 | Example 2 | Example 3 | Example 4 | Example 1 | Example 2 |
| Olefinic Polymer (B) + | Glass fibers-containing | mass % | 90 | 90 | 90 | 90 | 90 | 100 |
| Fibers (C) | polypropylene | | | | | | | |
| Olefinic Polymer (A) | Propylene polymer (A-1) | mass % | 10 | — | 5 | — | — | — |
| | Propylene polymer (A-2) | mass % | — | 10 | — | 5 | — | — |
| Olefinic Polymer (B) | Homopolypropylene | mass % | — | — | 5 | 5 | 10 | — |
| Content of Olefinic Polymer (A) (*1) | | mass % | 13.7 | 13.7 | 6.8 | 6.8 | 0 | 0 |
| Content of Fibers (C) | | mass % | 27 | 27 | 27 | 27 | 27 | 30 |
| Tensile Test | Tensile Breaking Strength | MPa | 66 | 67 | 69 | 69 | 72 | 77 |
| | Tensile Elastic Modulus | GPa | 4.1 | 4.1 | 4.3 | 4.3 | 4.6 | 5.1 |
| Impact Resistance | IZOD Impact Value (23° C.) | kJ/m² | 6.2 | 7.1 | 5.9 | 6.1 | 6.0 | 6.7 |
| Bending Test | Bending Strength | MPa | 97 | 98 | 102 | 103 | 109 | 117 |
| | Bending Elastic Modulus | GPa | 4.7 | 4.8 | 5.0 | 5.0 | 5.5 | 6.2 |
| Heat Resistance | Heat Distortion Temperature | ° C. | 160 | 160 | 161 | 161 | 162 | 165 |
| Flowability | Spiral Flow Length (SFL) | cm | 63 | 59 | 59 | 57 | 54 | 52 |
| Appearance of Molded | Surface Roughness Sa (point A) | μm | 0.9 | 0.8 | 1.0 | 1.0 | 1.0 | 1.2 |
| Article | Surface Roughness Sa (point B) | μm | 1.3 | 1.7 | 1.6 | 1.7 | 2.7 | 3.0 |
| | Surface Roughness Sa (point C) | μm | 17 | 17 | 17 | 13 | 26 | 35 |

(*1): Content relative to 100% by mass of the total content of the olefinic polymer (A) and the olefinic polymer (B).

The resin compositions of Comparative Examples not containing the olefinic polymer (A) have a short spiral flow length and the flowability thereof is low. The Sa value of these is higher with the increase in the distance from the injection position, and the surfaces of the molded articles are rough and have poor appearance. As opposed to these, the resin compositions of the present invention have a long spiral flow length and are excellent in flowability and, in addition, the Sa value thereof is low in the range from the intermediate part to the end part of the spiral flow, and the surface roughness of the molded articles is suppressed.

### INDUSTRIAL APPLICABILITY

The resin composition of the present invention is excellent in stiffness and heat resistance and is excellent in flowability and mold transferability, and gives a molded article excellent in appearance. The resin composition of the present invention is favorable for injection molding, and is especially favorable for use for automobile parts, construction members, civil engineering structure members, etc.

1: A resin composition, comprising:
(a) an olefinic polymer (A) having a melting endotherm (ΔH-D) of 0 J/g or more and 80 J/g or less, which is defined as the area of a peak observed on the highest temperature side in a melting endothermic curve obtained with a differential scanning calorimeter (DSC) by keeping a sample of the polymer in a nitrogen atmosphere at −10° C. for 5 minutes and then heating the sample at 10° C./min; and having a molecular weight distribution (Mw/Mn) of less than 3.0;
(b) an olefinic polymer (B) having a melting point (Tm-D) of 100° C. or higher, which is defined as the peak top observed on the highest temperature side in a melting endothermic curve obtained with a differential scanning calorimeter (DSC) by keeping a sample of the polymer in a nitrogen atmosphere at −10° C. for 5 minutes and then heating the sample at 10° C./min and
(c) fibers (C) having an aspect ratio of 10 or more and a mean fiber diameter of 0.01 μm or more and 1,000 μm or less.

2: The resin composition according to claim 1, wherein a content of the olefinic polymer (A) is 0.5% by mass or more and less than 50% by mass, relative to 100% by mass of a total content of the olefinic polymer (A) and the olefinic polymer (B).

3: The resin composition according to claim 1, wherein the olefinic polymer (A) is a propylenic polymer.

4: The resin composition according to claim 1, wherein the olefinic polymer (B) is a propylenic polymer.

5: The resin composition according to claim 1, wherein the olefinic polymer (A) is a propylenic polymer (a1) in which a propylene monomer accounts for 50 mol % or more of monomers constituting the polymer (a1).

6: The resin composition according to claim 5, wherein the propylenic polymer (a1) satisfies at least one of the following (i) and (ii):
(i) an ethylene structural unit is contained in an amount of more than 0 mol % and 20 mol % or less; and
(ii) a 1-butene structural unit is contained in an amount of more than 0 mol % and 30 mol % or less.

7: The resin composition according to claim 5, wherein the propylenic polymer (a1) satisfies the following (1):
(1) the meso pentad fraction [mmmm] is 20 mol % or more and 60 mol % or less.

8: The resin composition according to claim 5, wherein the propylenic polymer (a1) satisfies the following (2):
(2) the melting point (Tm-D), which is defined as the peak top observed on the highest temperature side in a melting endothermic curve obtained with a differential scanning calorimeter (DSC) by keeping a sample of the polymer in a nitrogen atmosphere at −10° C. for 5 minutes and then heating the sample at 10° C./min, is 0° C. or higher and 120° C. or lower.

9: The resin composition according to claim 7, wherein the propylenic polymer (a1) satisfies the following (3):
(3) the value of [rrrr]/(1−[mmmm]) is 0.1 or less.

10: The resin composition according to claim 7, wherein the propylenic polymer (a1) satisfies the following (4) and (5):
(4) the racemic meso racemic meso pentad fraction [rmrm] is more than 2.5 mol %; and
(5) the value of [mm]×[rr]/[mr]² is 2.0 or less.

11: The resin composition according to claim 1, wherein the fibers (C) are glass fibers.

12: The resin composition according to claim 1, wherein the fibers (C) are carbon fibers.

13: The resin composition according to claim 1, wherein the composition is adapted to function as a composition for injection molding.

14: A molded article, which is formed of the resin composition of claim 1.

15: An injection-molded article, which is formed of the resin composition of claim 1.
